(19) United States
(12) Patent Application Publication
(10) Pub. No.: US 2013/0068899 A1
(43) Pub. Date: Mar. 21, 2013

(54) CABLE FASTENING DEVICE

(71) Applicant: Jörg Richter, Schwabisch Hall (DE)

(72) Inventor: Jörg Richter, Schwabisch Hall (DE)

(73) Assignee: RECARO AIRCRAFT SEATING GMBH & CO. KG, Schwäbisch Hall (DE)

(21) Appl. No.: 13/695,643

(22) PCT Filed: May 3, 2011
(86) PCT No.: PCT/EP2011/002193

§ 371 Date: Dec. 6, 2012

(30) Foreign Application Priority Data
May 12, 2010 (DE) 10 2010 020 212.6

(51) Int. Cl. F16L 3/02

(52) U.S. Cl. CPC F16L 3/02
USPC 248/65

(57) ABSTRACT

A cable fastener includes at least two support units, at least one traverse element, a bearing unit and a retaining unit. The retaining unit is interposed between the at least two support units. At least part of the bearing unit is formed by at least one part of a support unit.

### CROSS REFERENCE TO RELATED APPLICATIONS

This application is a U.S. national stage application of PCT/EP2011/002193 filed on May 3, 2011, and claims priority to, and incorporates by reference, German patent application No. 10 2010 020 212.6 filed on May 12, 2010.

### BACKGROUND

The invention proceeds from a cable fastening device according to the preamble of patent claim 1.

Cable fastening devices having two support units, a transverse element, a bearing unit and a retaining unit, wherein the retaining unit is arranged between the two support units, are already known. The support units offer lateral retention of a cable to be fastened. The cable to be fastened is fastened in a known manner by a cable fastening unit, such as a cable tie, wherein the cable fastening unit runs through the transverse element, which is arranged between the support units.

In particular, the object of the invention is to provide a cable fastening device that enables increased installation security as a result of improved protection against damage of the cable to be fastened. This object is achieved in accordance with the invention by the features of claim 1. Further advantageous embodiments of the invention are disclosed in the dependent claims.

### SUMMARY

The invention proceeds from a cable fastening device comprising at least two support units, at least one transverse element, a bearing unit and a retaining unit, wherein the retaining unit is arranged between the at least two support units.

It is proposed for at least one part of the bearing unit to be formed by at least one part of one of the at least two support units. In this context, a “bearing unit” is to be understood in particular to mean a unit that is provided to provide a bearing surface and possibly lateral retention for a cable that is to be fastened. In this context, a “support unit” is to be understood in particular to mean a unit that is provided to distance the bearing unit from the retaining unit. In this case, a “transverse element” is to be understood to mean a unit that is provided to interconnect the at least two support units. In this context, a “retaining unit” is to be understood in particular to mean a unit that is provided to fasten the cable fastening device to a corresponding component, for example a metal plate.

A solution with increased installation security can be provided in a particularly simple manner by means of a corresponding embodiment according to the invention. The cable to be fastened can be protected advantageously against contact with a connecting element, whereby friction, and consequently potential damage to the cable to be fastened, can be prevented advantageously. A prescribed distance between the cable to be fastened, such as a live cable, and the corresponding component can be achieved, in particular in aircraft construction, by designing the at least two support units in a manner that appears to be expedient to a person skilled in the art.

It is further proposed for at least one of the at least two support units to have a continuous bearing surface for a cable to be fastened, whereby bearing forces can be transferred particularly uniformly onto at least one of the at least two support units. The bearing surface preferably extends on a side of one of the at least two support units facing away from the retaining unit.

If a distance between the at least two support units corresponds substantially to a width of one of the at least two support units, the cable fastening device can advantageously be fastened to the corresponding component irrespective of direction. In this context, “substantially” is to be understood in particular to mean a ratio of the distance between the at least two support units to the width of a support unit between 0.66 and 1.5, and more preferably between 0.75 and 1.33. A “width of a support unit” is to be understood to mean the overall width of one of the at least two support units.

If the fastener has two planes of symmetry, which are arranged perpendicular to a fastening plane of the retaining unit and perpendicular to one another, a particularly versatile arrangement of the fastener on the corresponding component can be achieved. In this context, a “plane of symmetry” is to be understood in particular to mean a plane through which the cable fastening device is formed in a substantially symmetrical manner.

The at least two support units may further be arranged between the retaining unit and the bearing unit, whereby the bearing unit can be easily distanced from the retaining unit, as a result of which a particularly high level of installation security can be provided.

If the at least two support units are connected directly by the at least one transverse element, additional stability of at least one of the at least two support units can be achieved. The at least one transverse element can preferably be formed as a side wall, and more preferably as a strut.

Furthermore, the retaining unit may have at least one continuous recess, whereby simple and secure fastening to the corresponding component can be achieved. The at least one continuous recess preferably has a countersink, which can receive parts of the connecting element, whereby the connecting element can be connected in a particularly compact manner to the retaining unit.

If the at least one transverse element has at least one fastening passage, the cable fastening unit can be connected to the cable fastening device in a simple manner. The fastening passage is preferably formed as a recess in the at least one transverse element, and more preferably as a recess in an underside, facing toward the retaining unit, of the at least one transverse element.

It is further proposed for at least one of the at least two carrier units to be formed continuously in at least one horizontal sectional plane, whereby a particularly high level of stability of the cable fastening device can be achieved.

If the bearing surface has curvatures in a continuous region in at least two spatial directions arranged perpendicular to one another, said curvatures corresponding substantially to curvatures of a cable to be fastened, bearing forces can be distributed particularly uniformly onto the bearing surface. In this context, a “curvature” in a point of the bearing surface, which is different from zero, is to be understood in particular to be a deviation growing quadratically with a distance from the point of the bearing surface. The bearing surface preferably has a curvature of zero in a direction that is oriented perpendicular to the at least one transverse element and horizontally.

It is further proposed for at least one of the at least two support units and/or the at least one transverse element and/or the bearing unit and/or the retaining unit to consist of plastic, at least in part, whereby the cable fastening device can be particularly light. In this context, “plastic” is to be understood in particular to mean a polymer from a group consisting of the polyamides, polyethylenes or polyvinyl chlorides. The entire cable fastening device preferably consists of a polyamide.

In a further embodiment it is proposed for the cable fastening device to have substantially cubical outer dimensions, which enables a particularly suitable combination of installation security and compactness. In this context, “cubical outer dimensions” is to be understood in particular to mean a ratio of the overall outer dimensions, wherein the ratio between any two dimensions is between 0.75 and 1.33.

### BRIEF DESCRIPTION OF THE DRAWINGS

Further advantages will emerge from the following description of the drawing. An exemplary embodiment of the invention is illustrated in the drawing. The description and the claims contain numerous features in combination. A person skilled in the art will also consider the features individually where expedient and will combine them in further sensible combinations.

FIG. 1 is a schematic perspective view of a cable fastening device according to the invention,

FIG. 2 is a schematic plan view of the cable fastening device according to FIG. 1,

FIG. 3 is a schematic sectional view through A-A, and

FIG. 4 is a schematic sectional view through a cable fastening system.

### DETAILED DESCRIPTION

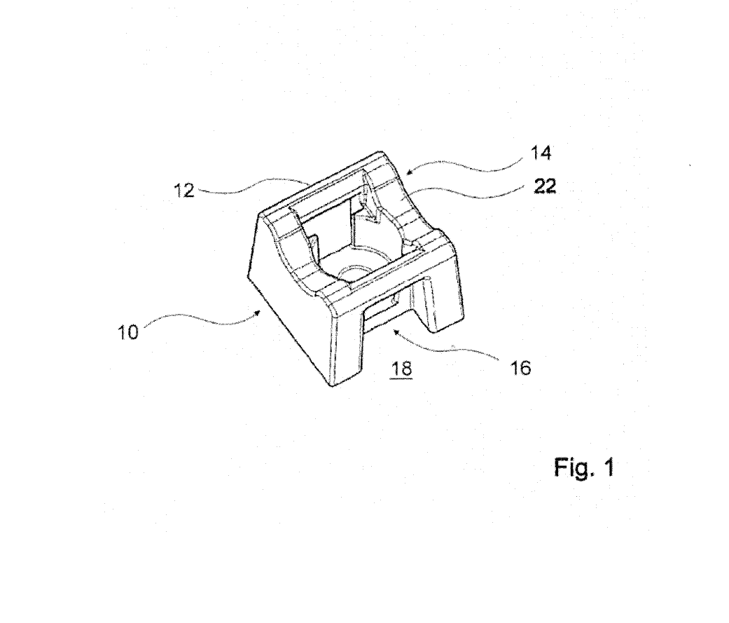

A cable fastening device according to the invention is illustrated in FIG. 1. It comprises two support units 10, two transverse elements 12, a bearing unit 14 and a retaining unit 16, wherein the retaining unit 16 is arranged between the two support units 10. The retaining unit 16 is arranged on a surface of a corresponding component 18, which extends in a fastening plane 20. Hereinafter, “horizontal” is to be understood to mean a direction parallel to the fastening plane 20 and “vertical” is to be understood to mean a direction perpendicular to the fastening plane 20. “Up” is to be understood to mean a direction that faces away from the fastening plane 20, and “down” is to be understood to mean a direction that faces toward the fastening plane 20. The support units 10 are arranged parallel to one another and are connected directly to the retaining unit 16. Each support unit 10 forms part of the bearing unit 14 on an upper side facing away from the fastening plane 20. The transverse elements 12 are arranged parallel to one another and perpendicular to the support units 10. Each transverse element 12 is connected directly at one of its ends to one of the support units 10.

The two support units 10 are connected directly to the retaining unit 16 and to the support unit 14. They distance the bearing unit 14 from the retaining unit 16 in a vertical direction.

The cable fastening device has a continuous bearing surface 22, which is formed by the upper side, facing away from the fastening plane 20, of the two support units 10.

The cable fastening device further has two planes of symmetry, which are arranged perpendicular to the fastening plane 20 and perpendicular to one another. One plane of symmetry runs parallel to the transverse elements 12. A sectional line of the planes of symmetry runs through a geometric midpoint of the cable fastening device. The cable fastening device is completely symmetrical with respect to the two planes of symmetry.

The two support units 10 are connected by the two transverse elements 12. The transverse elements 12 are arranged between the support units 10 in a primary direction of extension parallel to the fastening plane 20. At their ends, the transverse elements 12 are formed flush with the support units 10.

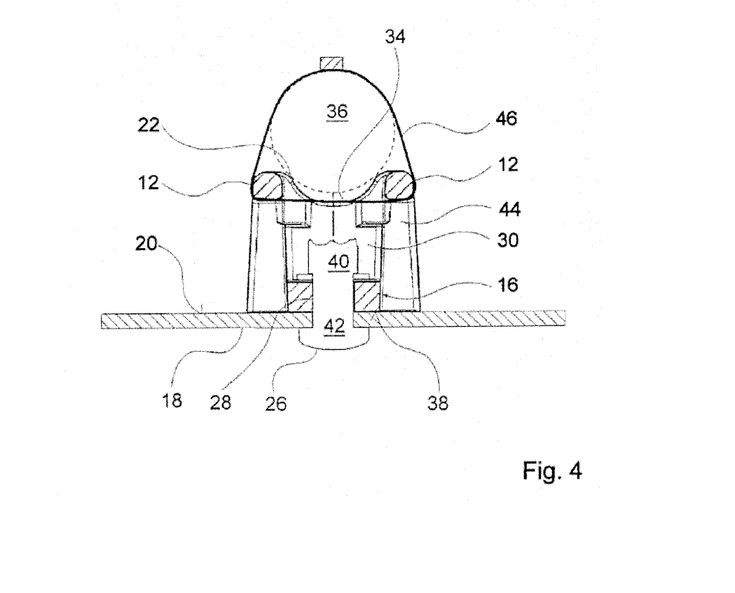

The retaining unit 16 has a continuous recess 24, which is provided to receive a connecting element 26, as illustrated in FIG. 4. The continuous recess 24 consists of a bore 28. A receiving region 30 for the connecting element 26 is illustrated above the bore 28.

As can further be seen in FIGS. 1 and 3, the support units 10 are fabricated in a continuous, solid piece. They are each formed continuously in a horizontal sectional plane 32, that is to say a sectional area produced by cutting though the sectional plane 32 is continuous.

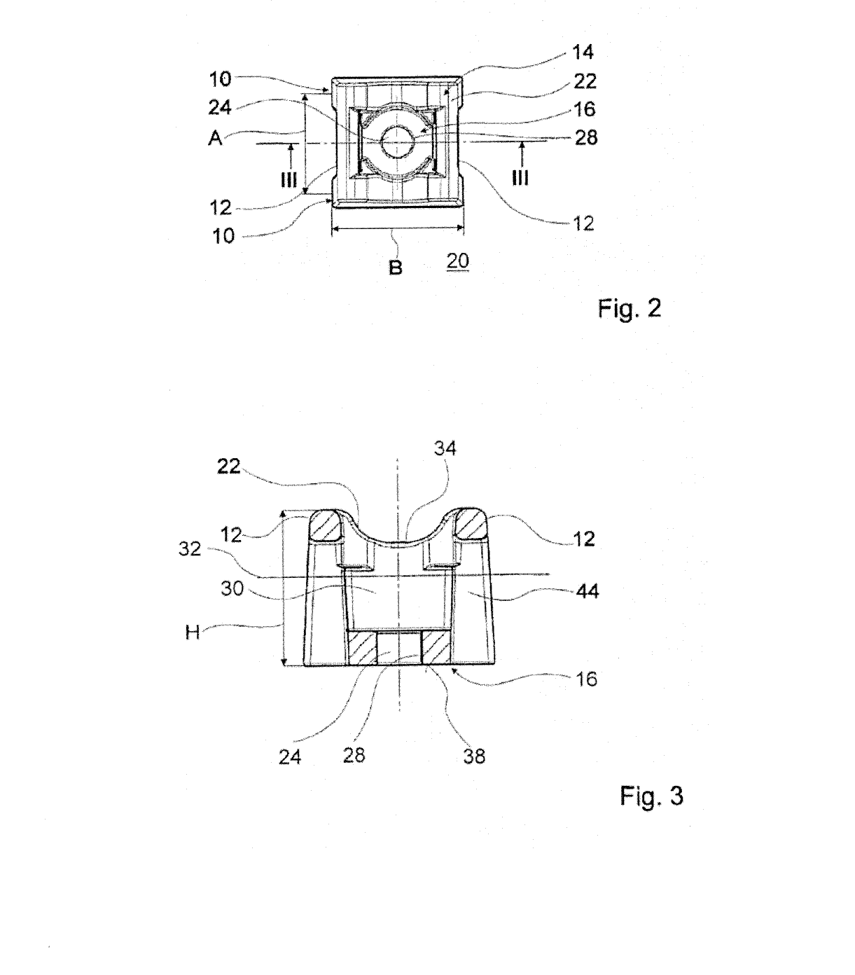

FIG. 2 shows a plan view of a ratio of a support unit width B to a support unit distance A. The support unit width B is defined by the overall length of one of the support units 10; the support unit distance A is defined as the distance between two support units 10. The continuous recess 24 is arranged centrally in the middle. It is shown that the support unit distance A corresponds to approximately 80% of the support unit width B.

As shown in FIGS. 2 and 3, a support unit height H of one of the support units 10 corresponds to approximately 82% of the support unit width B. The cable fastening device thus has substantially cubical outer dimensions.

As shown in FIG. 3, the bearing surface 22 has curvatures in a continuous region in two spatial directions arranged perpendicular to one another, wherein a curvature transverse to the transverse elements 12 results in a cavity-like indentation 34. A second curvature along the transverse elements 12 is kept to a minimum in the exemplary embodiment. Both curvatures correspond substantially to the curvatures of a cable 36 to be fastened, which results in a uniform distribution of a bearing force.

To keep the weight of the cable fastening device as low as possible, said cable fastening device is produced in one piece from nylon (polyhexamethylene adipamide) by injection molding, which makes it very resistant. The production costs for the cable fastening device are very low in this case.

As is further shown in FIG. 3, both transverse elements 12 have a fastening passage 44, which is provided to receive a cable fastening unit 46. The fastening passage 44 is defined laterally by the support units 10, upwardly by the transverse elements 12, and downwardly by the retaining unit 16. A second cable fastening unit (not illustrated) can thus also be passed through.

The cable fastening device is illustrated in FIG. 4 with the connecting element 26, with which the retaining unit 16 is fastened to the corresponding component 18. The retaining unit 16 rests flush against the corresponding component 18 via an underside 38. The connecting element 26 formed as a blind rivet is arranged in the continuous recess 24 in the retaining unit 16 and has an upper head 40 and a lower head 42 at its ends, with which a positive and non-positive connection is produced between the cable fastening device and the corresponding component 18.

In an assembled state, as shown in FIG. 4, a cable fastening system is equipped with the cable fastening device. The cable 36 rests on the bearing surface 22 and is held by the cable fastening unit 46. The connecting element 26, which is formed as a blind rivet and extends through the continuous recess 24 in the retaining unit 16, connects the cable fastening unit 46 to the corresponding component 18. The cable fastening unit 46 is formed by a cable tie. The cable tie extends beneath the transverse elements 12 through the fastening passage 44 and is closed over the cable 36. In the embodiment shown, the cable tie extends between the upper end of the blind rivet and the cable 36 and thus prevents contact on either side.

1. A cable fastening device comprising at least two support units, at least one transverse element, a bearing unit and a retaining unit, wherein the retaining unit is arranged between the at least two support units, characterized in that at least one part of the bearing unit is formed by at least one part of a support unit.

2. The cable fastening device as claimed in claim 1, wherein at least one of the at least two support units has a continuous bearing surface for a cable to be fastened.

3. The cable fastening device as claimed in claim 1, wherein a distance between the at least two support units corresponds substantially to a width of a support unit.

4. The cable fastening device as claimed in claim 1, further comprising two planes of symmetry, arranged perpendicular to a fastening plane of the retaining unit and perpendicular to one another.

5. The cable fastening device as claimed in claim 1, wherein the at least two support units are connected to the retaining unit and to the bearing unit.

6. The cable fastening device as claimed in claim 1, wherein the at least two support units are connected directly by the at least one transverse element.

7. The cable fastening device as claimed in claim 1, wherein the retaining unit has at least one continuous recess, which is provided to receive a connecting element.

8. The cable fastening device as claimed in claim 1, wherein the at least one transverse element has at least one fastening passage, which is provided to receive a cable fastening unit.

9. The cable fastening device as claimed in claim 1, wherein at least one of the at least two support units is formed continuously in at least one horizontal sectional plane.

10. The cable fastening device as claimed at least in claim 8, wherein the bearing surface has curvatures in a continuous region in at least two spatial directions arranged perpendicular to one another, said curvatures corresponding substantially to curvatures of a cable to be fastened.

11. The cable fastening device as claimed in claim 1, wherein the at least one of the at least two support units and/or the at least one transverse element and/or the bearing unit and/or the retaining unit consist of plastic, at least in part.

12. The cable fastening device as claimed in claim 1, further comprising substantially cubical outer dimensions.

13. A cable fastening system comprising a cable fastening device as claimed in claim 1, comprising a cable, a connecting element for connection to a corresponding component and a cable fastening unit for fastening the cable.

14. The cable fastening system as claimed in claim 13, wherein the cable fastening unit is formed as a cable tie.

15. The cable fastening system as claimed in claim 13, wherein the connecting element is formed as a blind rivet.

16. The cable fastening device as claimed in claim 2, wherein a distance between the at least two support units corresponds substantially to a width of a support unit.

17. The cable fastening device as claimed in claim 2, further comprising two planes of symmetry, arranged perpendicular to a fastening plane of the retaining unit and perpendicular to one another.

18. The cable fastening device as claimed in claim 3, further comprising two planes of symmetry, arranged perpendicular to a fastening plane of the retaining unit and perpendicular to one another.

19. The cable fastening device as claimed in claim 2, wherein the at least two support units are connected to the retaining unit and to the bearing unit.

20. The cable fastening device as claimed in claim 3, wherein the at least two support units are connected to the retaining unit and to the bearing unit.
